(19) United States
(12) Patent Application Publication
(10) Pub. No.: US 2023/0344091 A1
(43) Pub. Date: Oct. 26, 2023

(54) BATTERY PACK, ELECTRIC VEHICLE, AND ELECTRIC TOOL

(71) Applicant: MURATA MANUFACTURING CO., LTD., Kyoto (JP)

(72) Inventor: Yoshiyuki BANNAI, Kyoto (JP)

(21) Appl. No.: 18/216,278

(22) Filed: Jun. 29, 2023

Related U.S. Application Data
(63) Continuation of application No. PCT/JP2022/008631, filed on Mar. 1, 2022.

(30) Foreign Application Priority Data
Mar. 5, 2021 (JP) 2021-035393

(51) Int. Cl. H01M 50/526; H01M 50/516; H01M 50/503; H01M 50/213

(52) U.S. Cl. CPC H01M 50/526; H01M 50/516; H01M 50/503; H01M 50/213

(57) ABSTRACT

Provided are a battery pack capable of suppressing catching fire of surrounding a battery cell in a case where high-temperature gas is blown out from the battery cell when the battery cell is ignited, an electric vehicle including the battery pack, and an electric tool. The battery pack includes: a battery cell; a battery holder that houses the battery cell; and a connection member that electrically connects the battery cell, in which the battery holder has an end portion covering a side circumferential surface of the battery cell and forming an opening on a terminal portion side of the battery cell, the connection member includes a conductive portion and an insulating portion, and at least a part of the insulating portion and the end portion are connected with an adhesive member.

### CROSS REFERENCE TO RELATED APPLICATIONS

The present application is a continuation of PCT patent application no. PCT/JP2022/008631, filed on Mar. 1, 2022, which claims priority to Japanese patent application no. 2021-035393, filed on Mar. 5, 2021, the entire contents of which are incorporated herein by reference.

### BACKGROUND

The present application relates to a battery pack, an electric vehicle, and an electric tool.

Battery packs in which a battery cell group that has a plurality of battery cells such as lithium ion secondary batteries electrically connected is housed in an exterior case are widely used for electric vehicles, electric tools, and the like. As for the battery pack, there is a demand for a technique for suppressing, when an ignition occurs in one of the battery cells, the ignition from spreading to the entire battery pack.

A structure is described including: a battery holder that houses a plurality of battery cells; an upper plate that covers the entire upper side of the battery holder and is electrically connected to one electrode of a positive electrode and a negative electrode of the battery cell; and a lower plate that is arranged to face the upper plate, covers the entire lower side of the battery holder, and is electrically connected to another electrode of the positive electrode and the negative electrode of the battery cell.

A structure is described including a battery holder having a space through which each of a plurality of battery cells are inserted.

### SUMMARY

The present application relates to a battery pack, an electric vehicle, and an electric tool.

The techniques described in the Background section have room for improvement in terms of suppressing catching fire of surrounding battery cells when a battery cell in a battery cell group is ignited and high-temperature gas is blown out from the battery cell.

The present application relates to providing, in an embodiment, a battery pack with improved safety, and an electric tool and an electric vehicle including the battery pack.

The present application relates to, in an embodiment, a battery pack including:
a battery cell;
a battery holder that houses the battery cell; and
a connection member that electrically connects the battery cell,
in which
the battery holder has an end portion covering a side circumferential surface of the battery cell and forming an opening on a terminal portion side of the battery cell,
the connection member includes a conductive portion and an insulating portion, and
at least a part of the insulating portion and the end portion are connected with an adhesive member.

Furthermore, the present application may be an electric vehicle including the battery pack, or an electric tool including the battery pack according to an embodiment.

According to the present application, it is possible to provide a battery pack with further improved safety, an electric tool and an electric vehicle including the battery pack according to an embodiment.

### BRIEF DESCRIPTION OF THE FIGURES

FIG. 1 is an exploded perspective view showing an example of a configuration of a battery pack according to an embodiment.

FIG. 2 is a perspective view showing an example of the battery pack according to an embodiment.

FIG. 3 is an exploded perspective view showing an example of a battery holder that houses battery cells.

FIG. 4 includes views A to C, where views A and B are diagrams for describing a state in which an adhesive member is provided on a connection member, and where view C is a diagram schematically showing a section taken along line IVC-IVC in view A.

FIG. 5 includes views A to C, where views A and B are diagrams for describing a state in which the adhesive member is provided on the connection member, and where view C is a diagram schematically showing a section taken along line VC-VC in view A.

FIG. 6 is a partial sectional view showing an example of a positional relationship between the battery cells and an end portion of the battery holder.

FIG. 7 includes views A and B that are diagrams showing an example of a thin portion.

FIG. 8 includes views A and B that are diagrams showing an example of the thin portion.

FIG. 9 includes views A and B, where view A is a partial sectional view for describing an example of an exterior case, and where view B is a plan view for describing a positional relationship between the exterior case and the battery cells.

FIG. 10 is an exploded perspective view showing an example of a configuration of a battery pack using the exterior case of FIG. 9.

FIG. 11 is a partial sectional view for describing an example of the exterior case.

FIG. 12 is a partial sectional view for describing an example of the exterior case.

FIG. 13 is a diagram for describing an application example.

FIG. 14 is a diagram for describing an application example.

### DETAILED DESCRIPTION

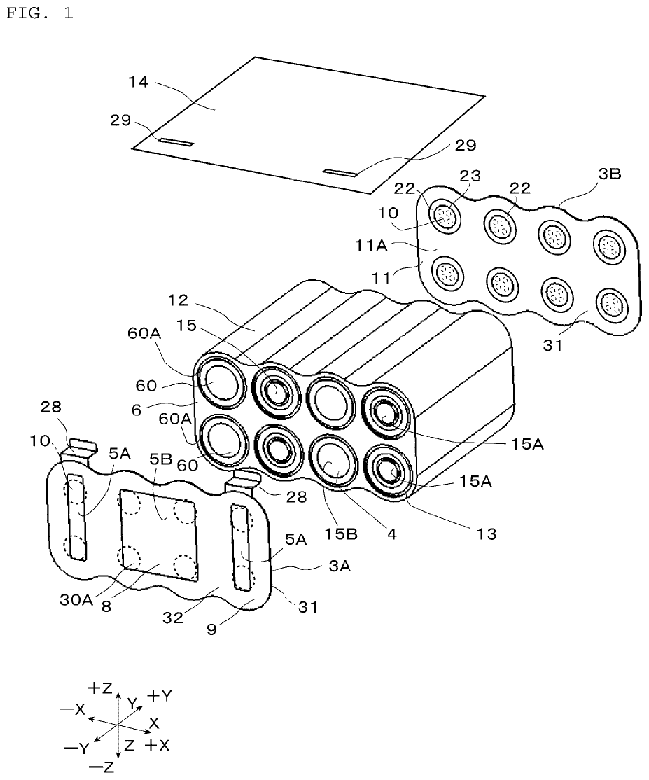

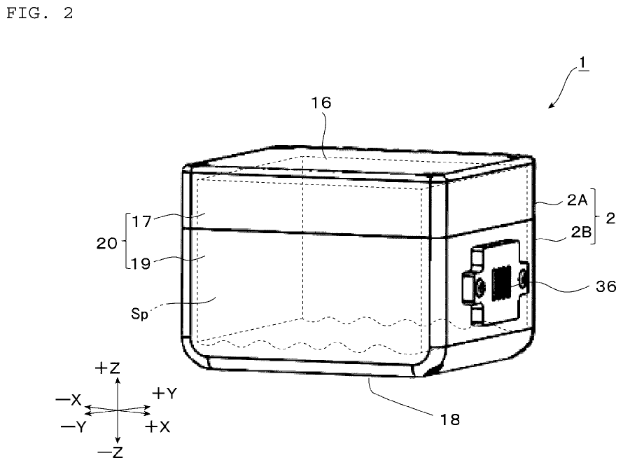

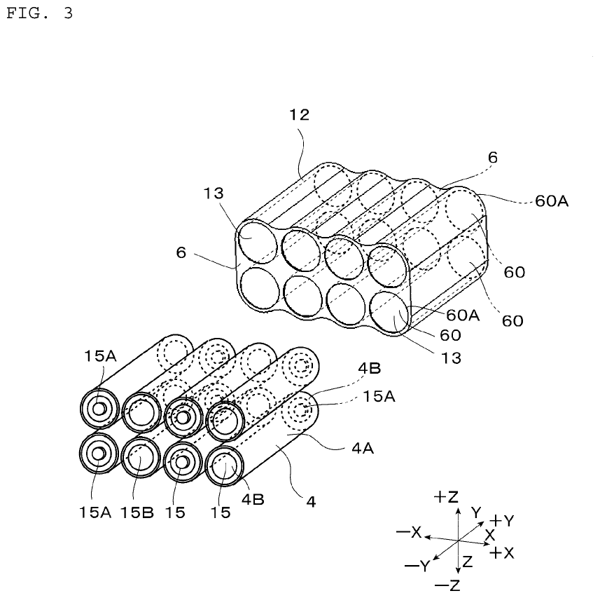

The present application is described below in further detail including with reference to the figures according to an embodiment. The present application is not limited thereto. In the following description, directions such as front and back, left and right, and up and down are indicated in consideration of convenience of description; however, the content of the present disclosure is not limited to these directions. In the examples of FIGS. 1 and 2, it is assumed that a Z-axis direction is an up-down direction (upper side is in the +Z direction, lower side is in the −Z direction), an X-axis direction is in a right-left direction (right side is in the +X direction, and left side is in the −X direction), and a Y-axis direction is in a front-rear direction (rear side is in the +Y direction, front side is in the −Y direction), and the description will be given based on the above assumption. The same applies to FIGS. 3 to 12. Unless otherwise specified, the relative magnitude ratio of the size and thickness of each part illustrated in each drawing of FIG. 1 is described for convenience, and does not limit the actual magnitude ratio. The same applies to the diagrams of FIGS. 2 to 14 regarding the definition and the magnitude ratio regarding these directions.

A battery pack (battery pack 1) according to an embodiment will be described with reference to FIGS. 1 to 3 and the like. FIG. 1 is an exploded perspective view for illustrating a configuration example of the battery pack 1. FIG. 2 is a view for describing an appearance of the battery pack 1. In FIG. 2, a battery holder 12 is housed in an exterior case 2 of the battery pack 1, but the description of the battery holder 12 is omitted for convenience of description.

The battery pack 1 includes a battery cell 4, the battery holder 12, and a connection member 3. In the example shown in FIG. 2 and the like, the battery pack 1 includes the exterior case 2 that houses the battery holder 12.

The battery holder 12 includes a battery cell housing portion 13 that covers a side circumferential surface 4A of the battery cell 4. In the examples shown in FIGS. 1, 3, and the like, the entire side circumferential surface 4A of the battery cell 4 is covered in the battery holder 12 with the battery cell 4 housed in the battery cell housing portion 13.

The battery holder 12 has an end portion 6 forming an opening 60. When the Y-axis direction is a line-of-sight direction, the opening 60 is formed at the end portion 6 such that an edge portion 60A of the opening 60 surrounds an electrode terminal portion 15 which is a terminal portion of the battery cell 4. The battery cell housing portion 13 is a space extending backward from the opening 60 of the end portion 6.

In the examples of FIGS. 1 and 3, the end portion 6 of the battery holder 12 is formed on both sides in the front-rear direction (+Y direction, −Y direction), and the opening 60 is formed in each end portion 6. The battery cell housing portion 13 is formed as a cylindrical space penetrating from the opening 60 of one end portion 6 toward the opening 60 of the other end portion 6. An axial direction of the battery cell housing portion 13 in the examples of FIGS. 1 and 3 is aligned in the front-rear direction, and with the battery cell 4 housed in the battery cell housing portion 13, the terminal portion (positive electrode terminal portion 15A) of a positive electrode of the battery cell 4 faces the one opening 60 side, and the terminal portion (negative electrode terminal portion 15B) of a negative electrode of the battery cell 4 faces the other opening 60 side. Note that the positive electrode terminal portion 15A and the negative electrode terminal portion 15B of the battery cell 4 may be referred to as an electrode terminal portion 15 for a terminal portion of the battery cell 4, in a case where the positive electrode and the negative electrode are not distinguished from each other or in a case where convenience of description is considered. The shape of the opening 60 formed at the end portion 6 of the battery holder 12 may be appropriately determined depending on an outer peripheral shape of the battery cell 4, and in the examples of FIGS. 1, 3, and the like, the opening is opened in a substantially circular shape.

In the examples shown in FIGS. 1, 3, and the like, the battery holder 12 is formed of a plurality of battery cell housing portions 13. The individual battery cell housing portions 13 are formed in the same tubular shape as one another. In addition, each of the battery cell housing portions 13 are formed side by side in the up-down direction (+Z direction, −Z direction) and the right-left direction (+X direction, −X direction). In the example of FIGS. 1 and 3, the battery cell housing portions 13 are arranged in four rows in the right-left direction and in two rows in the up-down direction, and each of the battery cells 4 is housed individually. What is shown here is an example. The battery cell housing portion 13 may have a shape other than the tubular shape. The number of rows in the right-left direction and the number of rows in the up-down direction in the battery cell housing portion 13 are not limited to the example of FIG. 1 and the like.

As a material of the battery holder 12, for example, a material having an insulating property is suitably used, and specifically, plastic or the like can be exemplified.

The battery cell 4 is not particularly limited, and for example, a lithium ion secondary battery, a lithium ion polymer secondary battery, or the like can be adopted. However, this does not restrict the battery cell 4 to be the other battery.

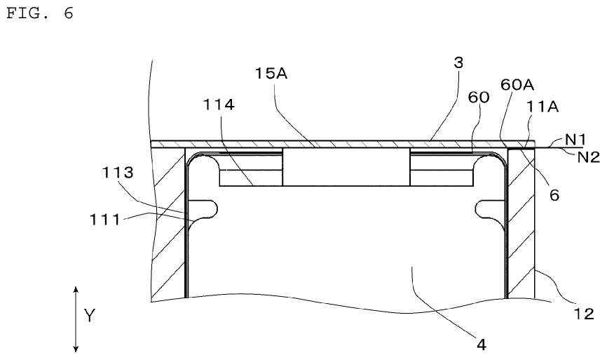

The shape of the battery cell 4 is not limited, but is preferably a cylindrical shape from a viewpoint of, for example, versatility, according to an embodiment. As partly shown in FIG. 6, the battery cell 4 includes an electrode wound body (not shown) inside a cylindrical battery can 111 as an exterior can, and an open end of the battery can 111 is closed by a battery lid 114. The electrode wound body has a structure in which a strip-shaped positive electrode and a strip-shaped negative electrode are spirally wound with a separator interposed therebetween, and are housed inside the battery can 111 in a state of being impregnated with an electrolytic solution. The battery lid 114 and a safety valve mechanism (not shown) are crimped at the open end of the battery can 111. Thus, the battery can 111 is sealed with an electrode wound body 120 and the like housed inside the battery can 111. Note that the safety valve mechanism mainly releases the sealed state of the battery can 111 as necessary when the internal pressure inside the battery can 111 increases. An insulating exterior tube 113 is provided on an outer peripheral surface of the battery can 111. The battery cell 4 is provided with the electrode terminal portions 15 as terminal portions on both end surfaces 4B thereof. One end surface 4B of the battery cell 4 has the positive electrode terminal portion 15A formed thereon as the electrode terminal portion 15, whereas the other end surface 4B of the battery cell 4 has the negative electrode terminal portion 15B formed thereon as the electrode terminal portion 15.

As described above, in the examples of FIG. 1 and the like, the plurality of battery cells 4 are housed in the battery holder 12. Regarding the arrangement of the battery cells 4 vertically adjacent to each other, the electrode polarities of the electrode terminal portions 15 exposed from the one end portion 6 side of the battery holder 12 are aligned. For example, the positive electrode terminal portions 15A of vertically adjacent battery cells 4 are directed toward one opening 60 side of the battery holder 12 (see FIG. 3). The negative electrode terminal portions 15B of vertically adjacent battery cells 4 are directed toward the other opening 60 side of the battery holder 12. When the arrangement of the electrode terminal portion 15 of the plurality of battery cells 4 housed in the battery holder 12 is viewed with a direction (Y direction) from one end portion 6 side to the other end portion 6 side of the battery cell 4 as a line-of-sight direction, the battery cells 4 are arranged such that the positive electrode terminal portion 15A and the negative electrode terminal portion 15B are alternately arranged in the right-left direction. The arrangement of the battery cells 4 described here is an example, and is not limited to the illustrated arrangement.

The electrode terminal portions 15 (positive electrode terminal portion 15A, negative electrode terminal portion 15B) of the battery cells 4 housed in the respective battery cell housing portions 13 of the battery holder 12 are electrically connected to the connection member 3. The connection member 3 includes a conductive portion 50 and an insulating portion 30. In the examples of FIG. 1 and the like, the connection member 3 is provided on both end portions 6, 6 sides of the battery holder 12. As the connection member 3, a first connection member 3A is provided on one end portion 6 side, and a second connection member 3B is provided on the other end portion 6 side. Hereinafter, the first connection member 3A and the second connection member 3B may be referred to as the connection member 3 in a case where the first connection member 3A and the second connection member 3B are not distinguished from each other or in a case where convenience of description is considered.

The conductive portion 50 is a portion through which electricity can pass when electrically connected to the electrode terminal portion 15, and is fixed to the electrode terminal portion 15 in a state of being in contact with the electrode terminal portion 15 of the battery cell 4. As a method of fixing the member forming the conductive portion 50 (lead plate 5 in the examples of FIG. 1 and the like) and the electrode terminal portion 15, welding or the like can be exemplified. Note that in the example of FIG. 1, reference numeral 23 indicated by a broken line indicates a portion to be a welded portion, and in this case, the individual electrode terminal portions 15 are welded at four portions of the conductive portion 50 of the connection member 3 (FIG. 1 illustrates a portion to be a welded portion 23 only for the second connection member 3B).

In the connection member 3, the conductive portion 50 is formed at least in a region facing the battery cell 4, and is exposed to a surface (facing surface 31) facing the battery cell 4. At least a part of the conductive portion 50 of the connection member 3 is exposed from the facing surface 31 side when an adhesive member 11A is provided on the facing surface 31 side of the connection member 3. As a result, it is possible to form a state in which the conductive portion 50 and the electrode terminal portion 15 of the battery cell 4 are joined to each other by welding or the like, and the conductive portion 50 and the battery cell 4 are electrically connected to each other.

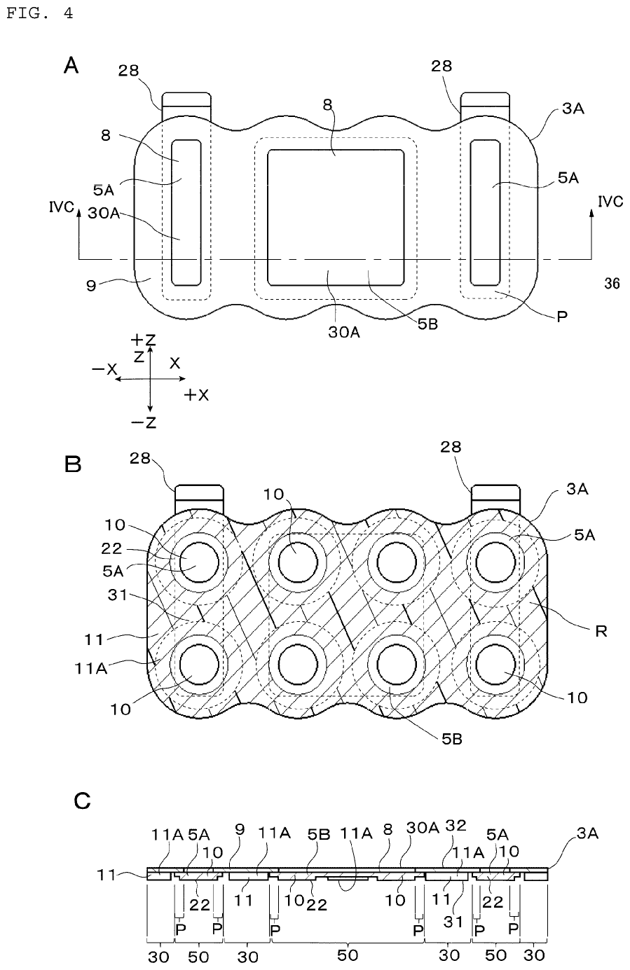

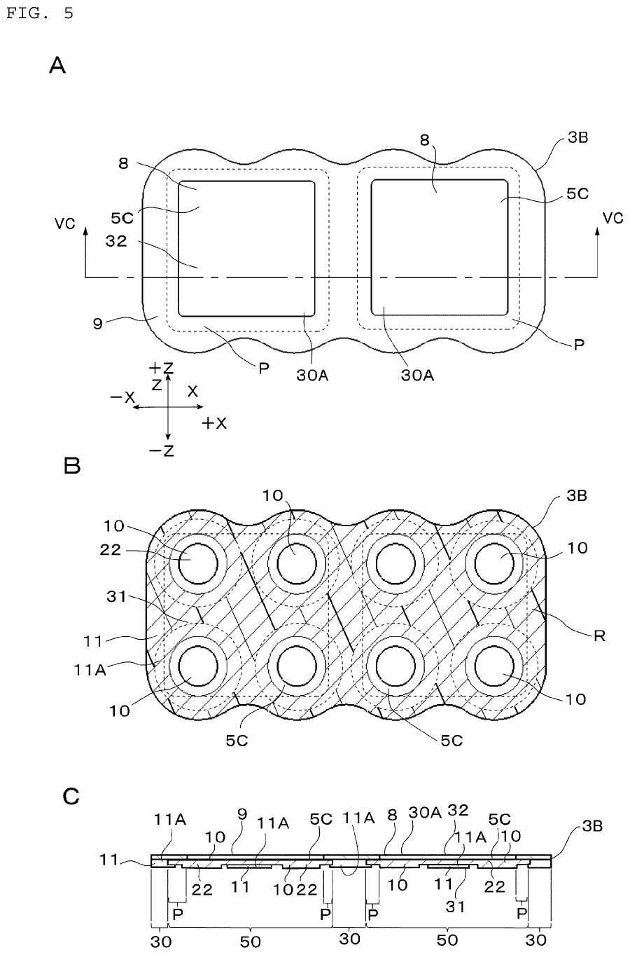

Regarding the state of the connection member 3 on the side opposite to the facing surface 31 (the side of non-facing surface 32 to the battery cell 4), it is preferable that at least a part of the conductive portion 50 is exposed to the side of non-facing surface 32 to the battery cell 4. For example, in the example of FIG. 4 and the like, portions of lead plates 5A and 5B, which will be described later, forming the conductive portion 50 excluding a bonding region P with a film material 9 forming the insulating portion 30, which will be described later, are exposed outward from an opening portion 30A. The exposed portion is an exposed portion 8. In the example of FIG. 5 and the like, portions of lead plate 5C, which will be described later, forming the conductive portion 50 excluding the bonding region P with the film material 9 forming the insulating portion 30, which will be described later, are exposed outward from the opening portion 30A, and the exposed portion 8 is formed at the exposed portion.

In the battery pack 1, since the lead plates 5A and 5B forming the conductive portion 50 are exposed to the non-facing surface 32 side with respect to the battery cell 4, when the battery cell 4 generates heat, the heat of the battery cell 4 is transferred to the conductive portion 50 close to the battery cell 4, and the heat is transferred from the facing surface 31 to the non-facing surface 32 side. Then, heat dissipation is efficiently realized from the non-facing surface 32 side toward the outside. As described above, according to the battery pack 1, efficient heat dissipation from the connection member 3 can be realized when the battery cell 4 generates heat.

The material of the conductive portion 50 is not particularly limited as long as it has conductivity. The conductive portion 50 is formed of a conductive material. For example, in the examples of FIGS. 1, 4, and the like, the conductive portion 50 is formed of the lead plate 5 formed of a conductive metal member as a conductive material.

In the battery pack 1 shown in the examples of FIGS. 1, 3, and the like, two board connecting lead plates (lead plates 5A) and a bipolar coupling lead plate (lead plate 5B) are provided as the conductive portion 50 of the first connection member 3A. Two bipolar coupling lead plates (lead plates 5C) are provided as the conductive portion 50 of the second connection member 3B. Note that hereinafter, the board connecting lead plate and the bipolar coupling lead plate of the first connection member 3A may be referred to as the lead plate 5A and the lead plate 5B, respectively. The bipolar coupling lead plate of the second connection member 3B may be referred to as the lead plate 5C. In addition, in a case where there is no need to distinguish the lead plates 5A, 5B, and 5C, or in a case where convenience of description is considered, they may be described as the lead plate 5.

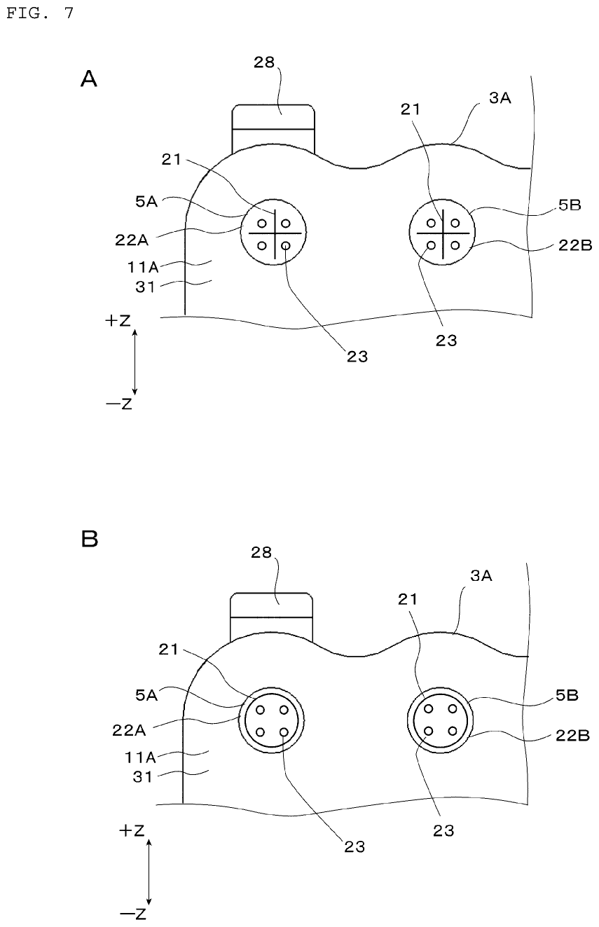

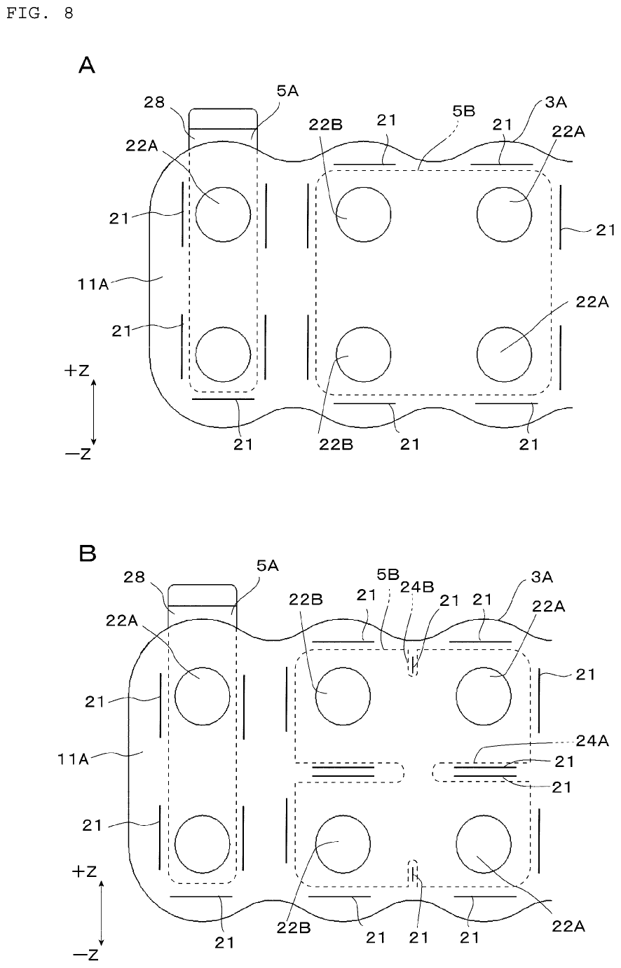

In the first connection member 3A, as shown in FIGS. 4A, 4B, and 4C, the lead plate 5A and the lead plate 5B are fixed to the film material 9 forming the insulating portion 30 described later. In the first connection member 3A, two lead plates 5A and 5B are arranged such that lead plate 5B is disposed between two lead plates 5A. In the second connection member 3B, as shown in FIGS. 5A, 5B, and 5C, the lead plate 5C is fixed to the film material 9 forming the insulating portion 30. In the second connection member 3B, two lead plates 5C are arranged. FIGS. 4A and 4B are a plan view and a rear view showing an embodiment in a state in which the adhesive member 11A is provided on the first connection member 3A, and FIG. 4C is a sectional view taken along line IVC-IVC of FIG. 4A. FIGS. 5A and 5B are a plan view and a rear view showing an embodiment in a state in which the adhesive member 11A is provided on the second connection member 3B, and FIG. 5C is a sectional view taken along line VC-VC of FIG. 4A. Note that in FIGS. 4B and 5B, a region where the adhesive member 11A is provided for each of the first connection member 3A and the second connection member 3B is indicated by hatching with one type of thin line, and an end portion facing region R, which will be described later, facing the end portion 6 of the battery holder 12 is indicated by hatching with two types of thin line and thick line. The same applies to FIGS. 7A, 7B, 8A, and 8B in that the state in which the adhesive member 11A is provided on the first connection member 3A is shown.

The board connecting lead plate (lead plate 5A) includes a terminal portion (substrate connection terminal 28) connected to a circuit board 14. The bipolar coupling lead plates (lead plates 5B, 5C) electrically connect the electrode terminal portions 15 having different polarities. As shown in FIG. 1, the electrode terminal portions 15 of the battery cells 4 facing the opening 60 on one end portion 6 side (end portion 6 side on the −Y direction side) of the battery holder 12 are joined to one of the lead plate 5A and the lead plate 5B of the first connection member 3A. The electrode terminal portions 15 of the battery cells facing the opening 60 on the other end portion 6 side (end portion 6 side on the +Y direction side) of the battery holder 12 are joined to the lead plate 5C of the second connection member 3B.

In the first connection member 3A, the two lead plates 5A are located on the right side (the side in the direction approaching an external connection terminal 36 as viewed in the right-left direction (+X direction side)) and the left side (the side in the direction away from the external connection terminal 36 as viewed in the right-left direction (−X direction side)) with respect to the lead plate 5B, and the lead plate 5A is joined to the electrode terminal portion 15 adjacent in the up-down direction. In the example of FIG. 1, the lead plate 5A on the right side is joined to two positive electrode terminal portions 15A and 15A, and the lead plate 5A on the left side is joined to two negative electrode terminal portions 15B and 15B. The lead plate 5B is joined to the electrode terminal portions 15 (in the example of FIG. 1, two positive electrode terminal portions 15A and two negative electrode terminal portions 15B) of the four battery cells 4 adjacent to each other in the right-left direction and the up-down direction.

In the second connection member 3B, the two lead plates 5C are arranged side by side along the X-axis direction. Respective lead plates 5C are joined to the electrode terminal portions 15 (in the example of FIG. 1, two positive electrode terminal portions 15A and two negative electrode terminal portions 15B) of the four battery cells 4 adjacent to each other in the right-left direction and the up-down direction.

On an upper end side of the lead plate 5A, a hook-shaped portion extending toward a center side of the battery holder 12 is formed on an upper surface of the battery holder 12. The hook-shaped portions form the substrate connection terminals 28 and 28, respectively. Receiving terminal portions 29 and 29 for connecting the substrate connection terminals 28 and 28 are formed on the circuit board 14 described later, and the respective substrate connection terminals 28 and 28 of the lead plates 5A and 5A are electrically connected to the circuit board 14 by being connected to the receiving terminal portions 29 and 29.

The lead plate 5A, the lead plate 5B, and the lead plate 5C are preferably formed of a copper alloy or a material similar thereto according to an embodiment. This allows power to be distributed with low resistance. The lead plate 5A, the lead plate 5B, and the lead plate 5C are formed of, for example, nickel or a nickel alloy. As a result, the weldability of the lead plate 5A, the lead plate 5B, and the lead plate 5C with the electrode terminal portion 15 is improved. Surfaces of the lead plate 5A, the lead plate 5B, and the lead plate 5C may be plated with tin or nickel. As a result, it is possible to prevent the surfaces of the lead plate 5A, the lead plate 5B, and the lead plate 5C from being oxidized and rusting.

The battery cells 4 housed in the battery holder 12 are electrically connected to each other by the lead plate 5A and the lead plate 5B of the first connection member 3A and the lead plate 5C of the second connection member. In the examples of FIG. 1 and the like, combinations of the two battery cells 4 arranged vertically are connected in parallel by the lead plate 5A, the lead plate 5B, and the lead plate 5C, and four sets of the combinations are electrically connected in series.

Note that the example of the lead plate 5 (lead plates 5A, 5B and 5C) provided on the connection member 3 is an example, and the number and arrangement of the lead plates 5, the shape, the material, and the like of each lead plate 5 can be appropriately set depending on the arrangement of the electrode terminal portions 15, the battery cells 4, and the like.

The connection member 3 has the insulating portion 30 as described above. The insulating portion 30 can be exemplified by a film material or the like having the insulating property. In the examples of FIGS. 4 and 5, and the like, the insulating portion 30 of the first connection member 3A and the insulating portion 30 of the second connection member 3B are each formed of the film material 9.

As shown in FIGS. 4A, 4B, and 4C, in the first connection member 3A, the lead plates 5A and 5B are fixed to one surface (facing surface 31) side of the film material 9 forming the insulating portion 30. Examples of the method for fixing the lead plates 5A and 5B to the film material 9 include a method for bonding the film material 9 and the lead plates 5A and 5B, and a resin insert molding method using a resin for forming the film material 9. As shown in FIGS. 5A, 5B, and 5C, in the second connection member 3B, the lead plates 5C are fixed to one surface (facing surface 31) side of the film material 9. As a method of fixing the lead plates 5C to the film material 9, a method similar to the method of fixing the lead plates 5A and 5B to the film material 9 may be adopted.

Examples of the material of the film material 9 forming the insulating portion 30 include polyimide and polycarbonate.

As shown in FIGS. 4, 5, and the like, it is preferable in the connection member 3 that a protrusion 10 is formed in a portion of the conductive portion 50 of the connection member 3 facing the electrode terminal portion 15 of the battery cell 4. The protrusion 10 is formed as a portion protruding in a direction from the conductive portion 50 toward the electrode terminal portion 15 of the battery cell 4. When the conductive portion 50 is formed of the lead plate 5, the protrusion 10 can be specifically formed by, for example, drawing the lead plate 5. Since the protrusion 10 is formed in the connection member 3, a contact state between the conductive portion 50 of the connection member 3 and the battery cell 4 can be further ensured when an adhesive portion 11 described later has a thickness. In a state in which the connection member 3 is adhered to the battery holder 12, the protrusion 10 is in contact with the electrode terminal portion 15 of the battery cell 4. The conductive portion 50 is welded to the electrode terminal portion 15 in the protrusion 10.

The battery holder 12 and the connection member 3 are adhered to each other with the adhesive member 11A. Hereinafter, a portion where the connection member 3 and the battery holder 12 are adhered by the adhesive member 11A may be referred to as the adhesive portion 11.

Examples of the adhesive member 11A include an adhesive and a sheet material having adhesiveness. Note that in the present specification, the concept of the adhesive includes a pressure-sensitive adhesive. In addition, the sheet material having adhesiveness includes a sheet material having pressure-sensitive adhesiveness. The material of the sheet material used for the sheet material having pressure-sensitive adhesiveness is not particularly limited, and the same material as the film material 9 forming the insulating portion 30 may be selected.

The type of the adhesive member 11A is not particularly limited as long as the connection member and the battery holder can be adhered to each other, and examples thereof include a rubber-based resin adhesive, an acrylic-based resin adhesive, a silicon-based resin adhesive, and a urethane-based resin adhesive. They may be one kind or a combination of a plurality of kinds. From a viewpoint of obtaining sufficient adhesive strength and high environmental resistance, it is preferable that the examples include the acrylic-based resin adhesive or the silicon-based resin adhesive.

The adhesive portion 11 is formed by, for example, curing the adhesive member provided between the adhesive member and the battery holder. The curing method (curing type) of the adhesive member is not particularly limited, and examples thereof include various curing methods such as a solvent volatilization type, a moisture curing type, a heat curing type, a curing agent mixing type, and an ultraviolet curing type. As a method for curing the adhesive member, it is preferable to, from a viewpoint of work efficiency and certainty of curing, use a heat curing type or the ultraviolet curing type.

In the examples of FIGS. 4 and 5, the adhesive member 11A can be provided between the connection member 3 and the battery holder 12 as follows, for example. The adhesive member 11A is applied or attached to a region of the connection member 3 including a region (hereinafter, referred to as the end portion facing region R) facing the end portion 6 of the battery holder 12. The connection member 3 to which the adhesive member 11A is applied or attached is adhered to the end portion 6 of the battery holder 12 with the adhesive member 11A, with the surface on the application side or the attachment side of the adhesive member 11A facing the end portion 6 of the battery holder 12. In this case, the adhesive member 11A is provided in the entire region of the end portion 6 of the battery holder 12. In this way, the adhesive portion 11 is formed between the end portion 6 of the battery holder and the connection member 3. Note that the adhesive member 11A is applied or attached to a region avoiding the welded portion 23 with the electrode terminal portion 15. This is because when the adhesive member 11A is provided at a position corresponding to the welded portion 23, an electrical connection between the battery cell 4 and the conductive portion 50 is impaired. In the example of FIG. 1, the welded portion 23 is formed on the protrusion 10. In such a case, as shown in the examples of FIGS. 4 and 5, it is preferable that, from a viewpoint of more reliably securing the electrical connection between the battery cell 4 and the conductive portion 50, the adhesive member 11A is applied or attached to a region avoiding the protrusion 10.

Note that the adhesive member 11A may be applied or attached to the end portion 6 of the battery holder 12. In this case, the connection member 3 and the battery holder 12 are adhered to each other with the adhesive member 11A by making the connection member 3 face the end portion 6 of the battery holder 12 to which the adhesive member 11A is applied or attached.

The end portion facing region R of the connection member 3 is a region including at least a part of the insulating portion 30. Therefore, at least a part of the insulating portion 30 and the end portion 6 are connected with the adhesive member 11A. As shown in FIGS. 4, 5, and the like, the end portion facing region R may include a part of the conductive portion 50.

In the examples of FIGS. 4A, 4B, 4C, 5A, 5B, and 5C, the adhesive portion 11 is provided in a region including the entire region (end portion facing region R) of the connection member 3 facing the end portion 6 with respect to the connection member 3, and the connection member 3 and the end portion 6 of the battery holder 12 are adhered to each other. In this case, the adhesive portion 11 is formed in a region including the end portion facing region R. With respect to the end portion 6 of the battery holder 12, the adhesive portion 11 is provided in the entire region of the end portion 6.

Note that this does not exclude that the adhesive portion 11 is formed in a partial region of the end portion facing region R. However, also in this case, the adhesive portion 11 is formed in the end portion facing region R such that the individual openings 60 are partitioned by the adhesive portion 11 in a case where the Y-axis direction is a line-of-sight direction. Therefore, for example, the adhesive portion 11 may be formed in a partial region of the end portion facing region R so as to surround the periphery of the edge portion 60A of each opening 60.

In the battery pack 1, since the adhesive portion 11 is formed, the individual battery cells 4 can be spatially isolated (separated). That is, first, the side circumferential surfaces 4A of the individual battery cells 4 are individually isolated by the battery cell housing portion 13. Further, the opening 60 of the end portion 6 of the battery holder 12 is covered with the connection member 3, and a gap between the edge portion 60A of the opening 60 and the connection member 3 is closed with the adhesive member 11A. As a result, both the side circumferential surface 4A and the end surface 4B of each of the battery cells 4 are spatially separated from the other battery cells 4. In this way, the battery pack 1 can include a structure in which the individual battery cells 4 are arranged in spaces isolated from each other, and the individual battery cells 4 are isolated individually.

In the battery pack 1, it is preferable that, from a viewpoint of maintaining the adhesion between the connection member 3 and the battery holder 12 by the adhesive member 11A (from a viewpoint of improving the adhesiveness), the end portion 6 of the battery holder 12 is located at the same position as or outside the electrode terminal portion 15 of the battery cell 4, in terms of the position in the inside-outside direction. However, in this case, the inside-outside direction is a direction from the inside to the outside of the battery holder 12 along the axial direction of the battery cell housing portion 13.

Specifically, in the example of FIG. 6, it is preferable that, in a case where a formation position of the opening 60 in the end portion 6 of the battery holder 12 is N1 and a tip position of the electrode terminal portion 15 (the positive electrode terminal portion 15A in the example of FIG. 6) is N2, the position N1 and the position N2 are at the same position in the position in the inside-outside direction (position in the Y-axis direction), or the position N1 is located outside the position N2. The example of FIG. 6 shows a case where the position N1 and the position N2 are at the same position.

When the position N1 of the opening 60 of the end portion 6 of the battery holder 12 and the position N2 of the electrode terminal portion 15 of the battery cell 4 are at the same position, a contact position between the connection member 3 and the electrode terminal portion 15 of the battery cell 4 and a contact position between the connection member 3 and the end portion 6 of the battery holder 12 can be approximately aligned in the inside-outside direction (Y-axis direction).

Incidentally, when the connection member 3 is provided in the battery holder 12, the opening 60 of the end portion 6 of the battery holder 12 is covered with the connection member 3, and the connection member 3 and the end portion 6 of the battery holder are adhered to each other by the adhesive member 11A. Usually, after this adhering, the electrode terminal portion 15 of the battery cell 4 housed in the battery cell housing portion 13 is welded to the conductive portion 50 of the connection member 3. At this time, when a contact position between the insulating portion 30 of the connection member 3 and the end portion 6 of the battery holder 12 is aligned in the inside-outside direction, a deflection of the connection member 3 is less likely to occur at the time of welding the conductive portion 50 and the electrode terminal portion 15, peeling between the connection member 3 and the end portion 6 of the battery holder 12 is less likely to occur, and unscheduled release of the adhering state between the connection member 3 and the battery holder 12 is further suppressed.

When the position N1 of the end portion 6 of the battery holder 12 is located outside the position N2 of the electrode terminal portion 15 of the battery cell 4, if the protrusion 10 is, as described above, formed in a portion of the conductive portion 50 of the connection member 3 facing the electrode terminal portion 15 of the battery cell 4, the deflection of the connection member 3 can be easily suppressed at the time of welding the conductive portion 50 and the electrode terminal portion 15.

When the position N1 of the end portion 6 of the battery holder 12 is located inside the position N2 of the electrode terminal portion 15 of the battery cell 4 (when the electrode terminal portion 15 is located outside the end portion 6), if a recess (not shown) is formed in a portion of the conductive portion 50 of the connection member 3 facing the electrode terminal portion 15 of the battery cell 4, a deflection of the connection member 3 can be suppressed at the time of welding the conductive portion 50 and the electrode terminal portion 15. However, normally, a negative electrode is formed around the positive electrode terminal portion 15A of the battery cell 4. For this reason, when the electrode terminal portion 15 is located outside the end portion 6, it is necessary to consider that when the above-described recess is formed in the connection member 3, the negative electrode around the positive electrode terminal portion 15A is likely to come into contact with the conductive portion 50 (a short circuit is likely to occur) at the time of welding the conductive portion 50 and the electrode terminal portion 15.

Note that in FIG. 6, the battery lid 114 contains a material similar to a material for forming the battery can 111. A central region of the battery lid 114 has a protrusion protruding in the outside direction (Y-axis direction in FIG. 6). The protrusion forms the electrode terminal portion 15 (positive electrode terminal portion 15A in the example of FIG. 6) of the battery cell 4. The tip position of the protrusion is the position N2.

The circuit board 14 is electrically connected to the external connection terminal 36 of the battery pack 1. In the example of FIG. 1, the circuit board 14 and the external connection terminal 36 are electrically connected via a wiring (not shown). The circuit board 14 is electrically connected to the substrate connection terminal 28 of the lead plate 5A, and is equipped with an electric circuit. The electric circuit is formed so that electric power from the battery cell 4 can be supplied from the external connection terminal 36 to the outside.

As shown in FIG. 2, the exterior case 2 includes an upper case 2A and a lower case 2B, and an internal space Sp is formed in a state where the upper case 2A and the lower case 2B are combined. As shown in FIG. 2, the internal space Sp in the exterior case 2 is a space for housing the battery holder 12 to which the connection member 3 is adhered. The circuit board 14 is also housed in the exterior case 2.

In the example of FIG. 2, the upper case 2A has a substantially rectangular upper surface portion 16. An upper peripheral wall portion 17 is erected downward (−Z direction) from the entire periphery of an outer edge of the upper surface portion 16. A depth of the upper case 2A (distance from a proximal end of the upper peripheral wall portion 17 to a distal end of the upper peripheral wall portion 17) is not particularly limited, and is shallower than a depth of the lower case 2B in the example of FIG. 2.

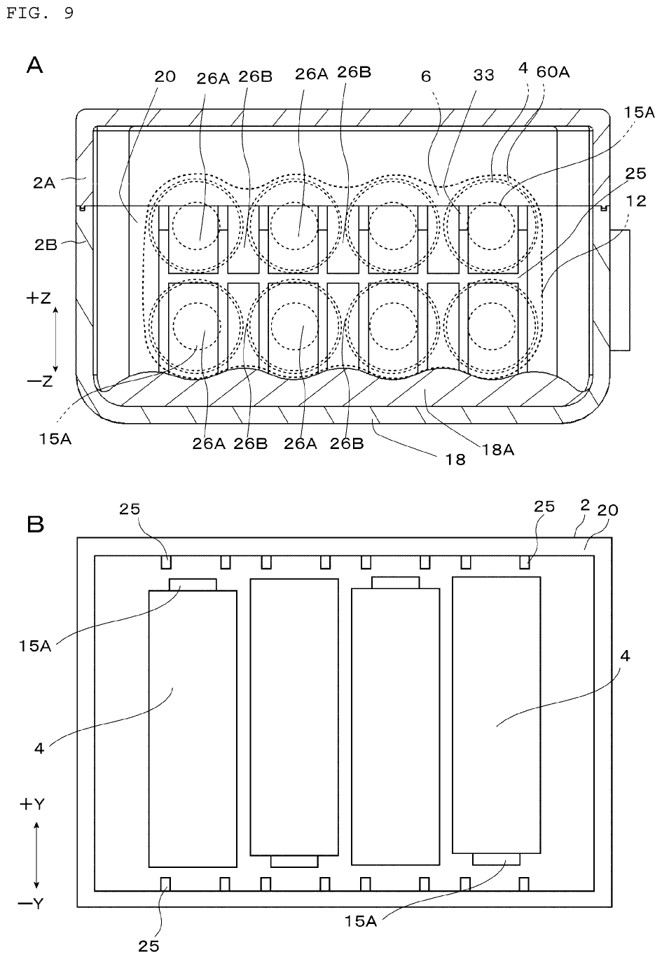

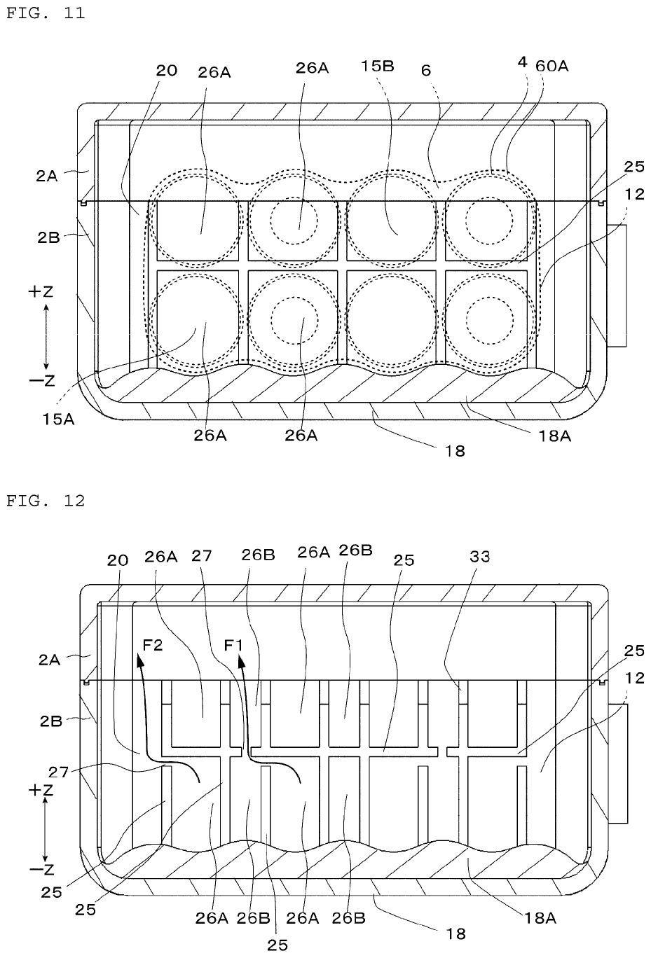

The lower case 2B has a substantially rectangular a bottom surface portion 18. A lower peripheral wall portion 19 is erected upward (+Z direction) from the entire periphery of an outer edge of the bottom surface portion 18. The exterior case 2 is formed by combining the upper case 2A and the lower case 2B. The upper case 2A and the lower case 2B are fixed to each other by a fixing member such as a screw in a state of being combined with each other. At this time, the upper peripheral wall portion 17 and the lower peripheral wall portion 19 form a peripheral wall portion 20. In addition, the shape of the bottom surface portion 18 is not particularly limited, but it is preferable that the inner surface shape of the bottom surface portion 18 is a shape matching the shape of the bottom surface of the battery holder 12, from a viewpoint of forming a state in which the battery holder 12 is stably disposed in the exterior case 2 (from a viewpoint of suppressing positional displacement). From the viewpoint of suppressing positional displacement, it is more preferable as shown in FIGS. 1 and 2 that an inner surface side (upper surface side) of the bottom surface portion 18 of the battery holder 12 is formed into a waved and curved surface shape, and the inner surface shape of the bottom surface portion 18 is formed into a curved surface shape matching the battery holder 12. Note that from the viewpoint of suppressing positional displacement, the inner surface shape of the bottom surface portion 18 may be an inner surface shape, and as shown in FIGS. 9A, 11, and the like, a laying member 18A formed in a curved surface shape whose upper surface matches the battery holder 12 may be laid on the bottom surface portion 18.

The materials of the upper case 2A and the lower case 2B, in an embodiment, are preferably materials having insulating properties and rigidity. Since the upper case 2A and the lower case 2B have insulating properties, a current is prevented from flowing out of the exterior case 2 from the battery cell 4. Since the upper case 2A and the lower case 2B have rigidity, the exterior case 2 has high robustness, and when the battery pack 1 is placed under a severe situation, it is easy to maintain a state in which the battery cell 4 can exhibit a function as a battery.

The exterior case 2 shown in the examples of FIG. 2, and the like is provided with the external connection terminal 36 for connecting the battery cell 4 and the outside at a predetermined position. In the example of FIG. 2, and the like, the external connection terminal 36 is fixed to the right end side (+X direction) of the lower case 2B. The fixing method is not particularly limited, but a method of fastening with a fixing screw at an outer peripheral edge position of the external connection terminal 36 can be used.

In the battery pack 1, the connection member 3 is connected to the end portion 6 of the battery holder 12 with the adhesive member 11A. At least a part of the insulating portion 30 of the connection member 3 forms the end portion facing region R facing the end portion 6 of the battery holder 12, the connection member 3 and the end portion 6 of the battery holder 12 are adhered to each other with the adhesive member 11A at a portion including at least a part of the end portion facing region R, the individual battery cell housing portions 13 are in a sealed state, and the spaces of the battery cell housing portions 13 are spatially separated from each other by the adhesive member 11A. Therefore, the individual battery cells 4 housed in the individual battery cell housing portions 13 can be spatially isolated from each other, and when a high-temperature gas is blown out from the battery cells 4 when any of the battery cells 4 housed in the battery holder 12 is ignited, it is possible to suppress catching fire of the surrounding battery cells 4.

In the battery pack 1, since the position of the end portion 6 of the battery holder 12 is located at the same position or outside in the inside-outside direction with respect to the position of the electrode terminal portion 15 of the battery cell 4, it is possible to suppress the deflection of the connection member 3, and it is easy to further maintain the adhesion between the end portion 6 of the battery holder 12 and the connection member 3. In this case, according to the battery pack 1, it is easy to maintain the effect of suppressing catching fire of surrounding battery cells 4 when any of the battery cells 4 housed in the battery holder 12 is ignited.

In the battery pack 1 according to an embodiment, a thin portion 21 may be formed in the connection member 3.

The thin portion 21 indicates a portion having a thickness smaller than the thickness around the thin portion 21. The thin portion 21 can function as a weakened portion that is more likely to break than its periphery. The weakened portion may be a structure other than the structure according to the thin portion of this example (for example, a structure in which a separate thin member is attached, or the like).

As shown in FIG. 7A, the thin portion 21 may be formed in the conductive portion 50 (first formation example). In the first formation example, the thin portion 21 is formed on a terminal facing portion 22. FIG. 7A is a plan view showing an example of the first formation example of the thin portion 21 of the connection member 3 used in the battery pack 1 according to an embodiment. Note that FIG. 7A shows an example of the first connection member 3A as the connection member 3. The same applies to FIGS. 7B, 8A, and 8B. Note that here the thin portion 21 will be described using the first connection member 3A as an example, but the thin portion 21 may be similarly formed in the second connection member 3B.

In the example of FIG. 7A, the entire thin portion 21 is formed in the terminal facing portion 22. In the battery pack 1, the welded portion 23 is formed at the time of welding the conductive portion 50 and the electrode terminal portion 15, and an electrical connection state between the connection member 3 and the battery cell 4 is fixed by the welded portion 23. In such a battery pack 1, the thin portion 21, in an embodiment, is preferably formed in a portion excluding the welded portion 23. In the example of FIG. 7A, the thin portion 21 is formed at a portion avoiding the four welded portions 23 in the terminal facing portion 22.

The method of forming the thin portion 21 in the first formation example is not particularly limited, but for example, the thin portion can be formed by imprinting a portion of the conductive portion 50 corresponding to the thin portion 21. Specifically, when the conductive portion 50 is the lead plate 5, the thin portion 21 can be formed by imprinting a portion of the lead plate 5 corresponding to the thin portion 21.

In the first formation example, the shape of the thin portion 21 is not particularly limited, and may be a cross shape as shown in FIG. 7A, or may be formed in a circular shape as shown in FIG. 7B. FIG. 7B is a plan view showing another embodiment of the first formation example.

The terminal facing portion 22 refers to a portion where the adhesive member 11A is not disposed (in the example of FIGS. 7A, 7B, and the like, a circular portion) in a portion of the connection member 3 facing the electrode terminal portion 15 of the battery cell 4, and includes the welded portion 23 with the electrode terminal portion 15. In the example of FIG. 7 and the like, the terminal facing portion 22 is a portion where formation of the adhesive portion 11 is avoided. As the terminal facing portion 22, a positive electrode facing portion 22A and a negative electrode facing portion 22B are formed.

The positive electrode facing portion 22A indicates a portion where the adhesive member 11A is not disposed in a portion of the conductive portion 50 facing the positive electrode terminal portion 15A of the end surface 4B of the battery cell 4, and includes the welded portion 23 with the positive electrode terminal portion 15A.

The negative electrode facing portion 22B indicates a portion where the adhesive member 11A is not disposed in a portion of the conductive portion 50 facing the negative electrode terminal portion 15B of the end surface 4B of the battery cell 4, and includes the welded portion 23 with the negative electrode terminal portion 15B. In the example of FIG. 1 and the like, both the terminal facing portion 22 corresponding to the positive electrode facing portion 22A and the portion corresponding to the negative electrode facing portion 22B correspond to the portion formed by the outer periphery portion of the protrusion 10 and the protrusion 10. Note that when the positive electrode facing portion 22A and the negative electrode facing portion 22B are not distinguished from each other, description of the terminal facing portion 22 is used.

In the first formation example, the thin portion 21 may be formed on at least one of the positive electrode facing portion 22A and the negative electrode facing portion 22B, but it is preferable that the thin portion 21 is formed in a portion excluding the welded portion 23 in each of the positive electrode facing portion 22A and the negative electrode facing portion 22B. Since the thin portion 21 is formed on each of the positive electrode facing portion 22A and the negative electrode facing portion 22B, the degassing effect by the thin portion 21 can be more reliably achieved.

As shown in FIG. 8A, the thin portion 21 may be formed in the insulating portion 30 (second formation example). Here, the thin portion 21 will be described using the first connection member 3A as an example with reference to FIG. 8A and the like, but the thin portion 21 may be similarly formed in the second connection member 3B. As shown in FIG. 8A, the thin portion 21 in the second formation example is formed in a portion of the insulating portion 30 corresponding to the outer periphery of the terminal facing portion 22. The terminal facing portion 22 in the second formation example is also a portion similar to the terminal facing portion 22 described in the first formation example.

In the second formation example, the thin portion 21, in an embodiment, is preferably formed in a portion of the insulating portion 30 along the outer periphery of the conductive portion 50. In the example of FIG. 8A, the thin portion 21 is formed linearly along the outer periphery of the lead plate 5 (lead plate 5A, 5B) for each terminal facing portion 22. The thin portion 21 may be formed so as to surround at least a part of the outer periphery of the terminal facing portion 22. In the example of FIG. 8A, the thin portions 21 are formed at two positions on the upper side and the lateral side of the outer periphery of the lead plate 5B with respect to the individual terminal facing portions 22 of the lead plate 5B, the terminal facing portions 22 on the upper side (+Z direction side) of the lead plate 5A are formed at two positions on both lateral sides of the outer periphery of the lead plate 5A, and the terminal facing portions 22 on the lower side (+Z direction side) of the lead plate 5A are formed at three positions on both lateral sides and the lower side of the outer periphery of the lead plate 5A.

It is preferable that the thin portions 21 formed around the adjacent terminal facing portions 22 are separated from each other. As a result, when the thin portion 21 formed in the outer periphery of one terminal facing portion 22 is broken, it is suppressed that the thin portion 21 formed in the outer periphery of the terminal facing portion 22 adjacent to the terminal facing portion 22 is broken in a chain manner.

It is also preferable that two or more thin portions 21 are formed between the adjacent terminal facing portions 22. In this case, when the thin portion 21 formed around one terminal facing portion 22 is broken, it is difficult release the sealed state in the battery cell housing portion 13 formed at the position of the terminal facing portion 22 adjacent with the broken thin portion 21 interposed therebetween. When the gas is released from the battery cell 4 to the outside, the gas is suppressed from entering the adjacent battery cell housing portion 13.

The method of forming the thin portion 21 in the second formation example is not particularly limited, but for example, the thin portion can be formed by cutting a portion of the insulating portion 30 corresponding to the thin portion 21 to a predetermined depth in the thickness direction of the insulating portion 30. Specifically, when the insulating portion 30 is the film material 9, the thin portion 21 can be formed by cutting a portion of the film material 9 corresponding to the thin portion 21 to a predetermined depth in the thickness direction of the film material 9.

In the second formation example, the number of formation places of the thin portion 21 formed on the outer periphery of one terminal facing portion 22 is not particularly limited, and may be two as shown in FIG. 8A, may be four as shown in FIG. 8B, or may be three or five or more although not shown. In the example shown in FIG. 8B, cut portions (first cut portion 24A, second cut portion 24B) are formed in lead plate 5 forming the conductive portion 50, and the thin portion 21 is formed along the outer periphery of each of the first cut portion 24A and second cut portion 24B. In this case, the thin portions 21 are formed at four positions on the upper side, the lower side, and the lateral side of the outer periphery of one terminal facing portion 22. In FIG. 8B, two thin portions 21 are formed between the adjacent terminal facing portions 22 at the position of the tongue-shaped first cut portion 24A extending in the lateral direction (direction crossing the Z axis), and one thin portion 21 is formed between the adjacent terminal facing portions 22 at the position of the tongue-shaped second cut portion 24B extending in the longitudinal direction. Note that the shapes of the first cut portion 24A and the second cut portion 24B shown in FIG. 8B are examples, and the present application is not limited to the examples.

In the second formation example, the shape of the thin portion 21 formed on the outer periphery of one terminal facing portion 22 is not limited to a linear shape, and may be appropriately determined to be a wave shape or the like.

In the second formation example, the thin portion 21 may be formed on the outer periphery of at least one of the positive electrode facing portion 22A and the negative electrode facing portion 22B, but it is preferable that, as shown in the examples of FIGS. 8A and 8B, the thin portion 21 is formed on the outer periphery corresponding to each of the positive electrode facing portion 22A and the negative electrode facing portion 22B.

The first formation example and the second formation example may be combined. That is, in an embodiment, the thin portion 21 may be formed on both the conductive portion 50 and the insulating portion 30 of the connection member 3.

According to the battery pack 1 of an embodiment, since the thin portion 21 is formed in the connection member 3, when gas is generated from the battery cells 4, it is possible to smoothly perform degassing of the battery cells 4 to the outside of the battery holder 12 while suppressing an induced explosion of surrounding battery cells.

More specifically, when, for example, the pressure (internal pressure) inside the battery cell 4 increases, the safety valve mechanism formed in the portion of the electrode terminal portion 15 of the battery cell 4 operates, and the gas released from the inside of the battery cell 4 presses the connection member 3 outward to cleave the thin portion 21 cleaves, which can smoothly realize the release (degassing) of the internal pressure of the battery cell 4. At this time, the sealed state of the surrounding battery cells 4 can be maintained, and an influence of catching fire, explosion induction, and the like of the surrounding battery cells due to the gas at the time of degassing can be suppressed.

The safety valve mechanism described above mainly refers to a structure in which when the pressure (internal pressure) inside the battery can 111 increases, the internal pressure is released by releasing the sealed state of the battery can 111 as necessary. As one of causes of an increase in the internal pressure of the battery can 111, a gas generated due to a decomposition reaction of the electrolytic solution impregnated into the electrode wound body during charging and discharging can be exemplified. The safety valve mechanism is usually provided in the vicinity of the battery lid 114 in the battery cell 4.

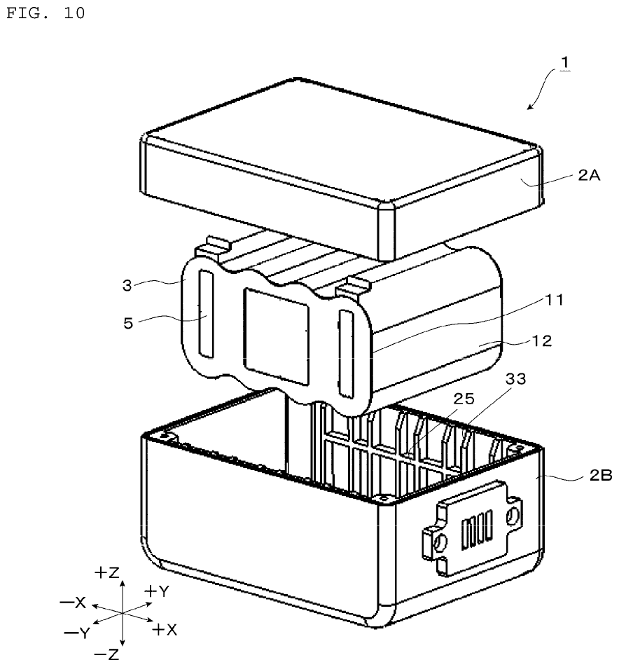

In the battery pack 1 according to an embodiment, a rib 25 may be formed on the inner surface side of the peripheral wall portion 20 of the exterior case 2 having the upper case 2A and the lower case 2B, as shown in FIGS. 9A, 9B, 10, and the like. FIG. 9A is a sectional view showing an example in which the rib 25 is formed in the exterior case 2. Note that in FIG. 9A, a state in which the battery holder 12 housing the battery cells 4 is disposed in the exterior case 2 is virtually indicated by a broken line. In FIG. 9A, for convenience of description, both the positive electrode terminal portion 15A directed toward the +Y direction side and the positive electrode terminal portion 15A directed toward the −Y direction side are virtually indicated by the broken lines. FIG. 9B shows a positional relationship between the rib 25 and the battery cell 4 in the example of FIG. 9A. Note that in FIG. 9B, hatching of a section and description of the battery holder 12 are omitted for convenience of description. FIG. 10 is an exploded perspective view of the battery pack 1 using the exterior case 2 having the rib 25. In FIG. 10, description of the circuit board 14 is omitted for convenience of description.

In the battery pack 1 according to an embodiment, the rib 25 is provided on the inner surface side of the peripheral wall portion 20 of the exterior case 2 so as to be in contact with the connection member 3. In the examples of FIGS. 9A, 9B, and 10, the rib 25 is formed on the inner surface side of the peripheral wall portion 20 (lower peripheral wall portion 19) of the lower case 2B of the exterior case 2. This does not exclude that the rib 25 is also formed on the inner surface side of the peripheral wall portion 20 (upper peripheral wall portion 17) of the upper case 2A. In addition, the rib 25, in an embodiment, is preferably formed on the inner surface of the peripheral wall portion 20 facing two end portions 6 of the battery holder 12 in the region on the inner surface side of the peripheral wall portion 20.

The rib 25 is provided at a position avoiding a position overlapping the electrode terminal portion 15 when a direction (Y-axis direction) from the peripheral wall portion 20 toward the end portion 6 of the battery holder 12 is a line-of-sight direction. In the examples of FIGS. 9A and 9B, the rib 25 is provided at a position where a position overlapping the positive electrode terminal portion 15A can be avoided. In addition, the arrangement form of the rib 25 is a lattice shape. Further, when the directions of the positive electrode terminal portions 15A of all the battery cells 4 are aligned, the rib 25 is formed such that the individual positive electrode terminal portions 15A are located in mutually different regions partitioned by the rib 25 in the region on the inner surface side of the peripheral wall portion 20. Hereinafter, in the region on the inner surface side of the peripheral wall portion 20 when the directions of the positive electrode terminal portions 15A of all the battery cells 4 are aligned, a partitioned region facing the positive electrode terminal portion 15A may be referred to as a first partitioned region 26A, and a partitioned region excluding the first partitioned region 26A may be referred to as a second partitioned region 26B. In the examples of FIGS. 9A and 9B, the first partitioned region 26A and the second partitioned region 26B are alternately arranged in the right-left direction (X-axis direction). In the up-down direction (Z-axis direction), the first partitioned regions 26A are side by side, and the second partitioned regions 26B are side by side.

However, the above arrangement form of the rib 25 is an example, and the present application is not limited thereto. For example, the first partitioned regions 26A of the rib 25 may be arranged side by side in the right-left direction (X-axis direction). In the example of FIG. 11, the arrangement form of the rib 25 is determined such that the first partitioned regions 26A are adjacent not only in the right-left direction but also in the up-down direction. In this case, the second partitioned region 26B is omitted. Note that in FIG. 11, a state in which the battery holder 12 housing the battery cells 4 is disposed in the exterior case 2 is virtually indicated by a broken line. Further, in FIG. 11, for convenience of description, a virtual broken line illustration of the positive electrode terminal portion 15A directed toward the +Y direction side (direction from front surface to back surface side on paper surface shown in FIG. 11) is omitted.

The rib 25 is not particularly limited as long as it is formed in a shape rising from the peripheral wall portion 20 toward the internal space Sp of the exterior case 2, but in the example of FIG. 10, the rib vertically rises from the inner surface side of the peripheral wall portion 20. Further, the rib 25 is formed so as to gradually rise from a predetermined position on the upper end side toward the upper end (tapered portion 33). With such a configuration, the battery holder 12 can be smoothly housed in the exterior case 2 from the upper side to the lower side. In addition, the tapered portion 33 is preferably formed, in an embodiment, on the inner surface of the peripheral wall portion 20 facing two end portions 6 of the battery holder 12 in the region on the inner surface side of the peripheral wall portion 20.

In the battery pack 1 according to an embodiment, the rib 25 is provided at a predetermined position on the inner surface side of the peripheral wall portion 20 of the exterior case 2, and the connection member 3 is in contact with the rib 25 in a state in which the battery holder 12 is housed in the exterior case 2. As a result, when gas is blown out from the battery cells 4 to the outside and a pressing force by the gas is applied to the connection member 3 in the outward direction, it is possible to suppress a possibility that the connection member 3 is peeled off from the battery holder 12 by the pressing force. Specifically, in a case where, for example, the safety valve mechanism of the battery cell 4 operates to blow out gas from the battery cell 4 to the outside when the internal pressure (internal pressure) of the battery cell 4 increases, the portion of the rib 25 forming the first partitioned region 26A is in contact with the connection member 3, which can suppress the possibility that the connection member 3 is peeled off from the battery holder 12 by an ejection force of the gas.

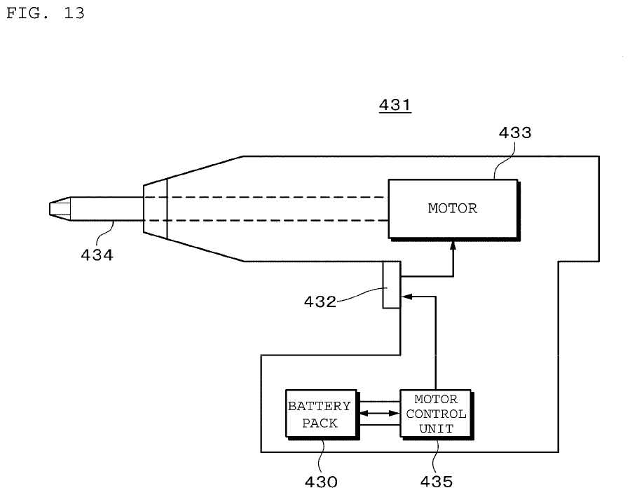

In the battery pack 1 according to an embodiment, as shown in FIG. 12, the rib 25 is preferably provided with a cutout portion 27.

In an embodiment, the cutout portion 27 is formed at a position where a gas discharge path F1 and a gas discharge path F2 are formed from the first partitioned region 26A toward the outside of the first partitioned region 26A.

In the example of FIG. 12, the cutout portion 27 is formed in a portion of the rib 25 that partitions the first partitioned region 26A and the second partitioned region 26B and a portion of the rib 25 that forms the second partitioned region 26B adjacent to the first partitioned region 26A. As a result, when the gas is ejected from the battery cell 4 facing the terminal facing portion 22 corresponding to the first partitioned region 26A, and the portion of the connection member 3 facing the battery cell 4 is destroyed and the gas is blown out into the space of the first partitioned region 26A, the ejected gas can be guided to the upper surface side of the battery holder 12 via the discharge paths F1 and F2. Note that the discharge path F1 is a path for guiding gas to the upper surface side of the battery holder 12 through the cutout portion 27 of the first partitioned region 26A, through the first partitioned region 26 A to the second partitioned region 26B, and further through the cutout portion 27 formed in the second partitioned region 26B. The discharge path F2 is a path for guiding gas to the upper surface side of the battery holder 12 through the cutout portion 27 of the first partitioned region 26A. Note that from a viewpoint of efficient guidance of the ejected gas, it is preferable that the cutout portion 27 is formed in the rib 25 formed on the inner surface of the peripheral wall portion 20 facing each of the two end portions 6 of the battery holder 12 in the region on the inner surface side of the peripheral wall portion 20.

In the battery pack 1 of an embodiment, as for the battery cell 4 housed in the battery holder 12, the case where the positive electrode terminal portion 15A is formed in a shape protruding from the center of one end surface 4B and the negative electrode terminal portion 15B is formed in a planar shape on the other end surface 4B side of the battery cell 4 is an example of the battery cell 4. The battery cell 4 housed in the battery pack 1 is not limited to this example, and the negative electrode terminal portion may be formed in a shape protruding from the center of one end surface of the battery cell, whereas the positive electrode terminal portion may be formed in a planar shape on the side with the other end surface of the battery cell. The battery cells may have the same appearance shape as the battery cells housed in the battery holder 12, and the polarity of the positive electrode and the polarity of the negative electrode may be exchanged and also functions and effects similar to the functions and effects described herein can be exhibited according to an embodiment.

As application examples, an electric tool and an electric vehicle including the above-described battery pack 1 will be described below as examples according to an embodiment.

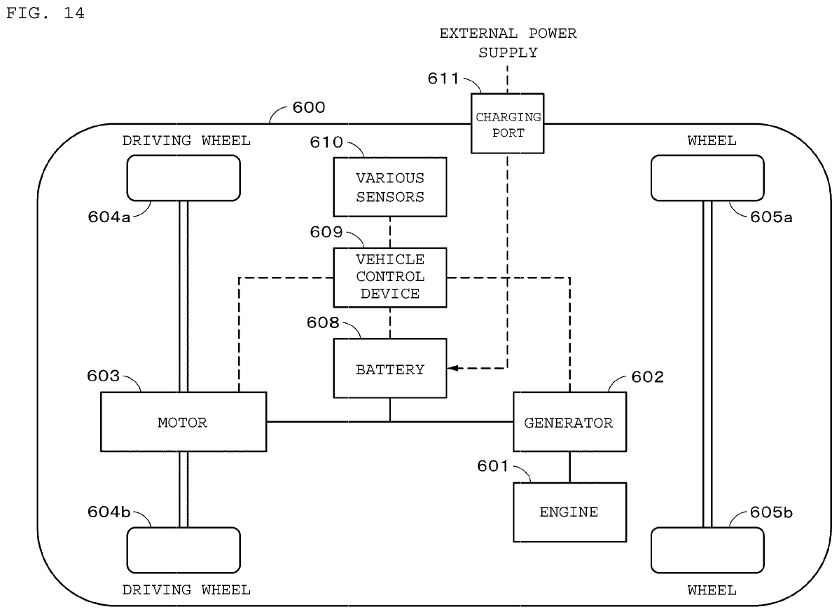

As an electric tool, for example, an electric driver is taken as an example, and an electric driver 431 described with reference to FIG. 13 houses a motor 433 such as a DC motor in a main body as shown in FIG. 13. The rotation of the motor 433 is transmitted to a shaft 434, and the shaft 434 drives a screw into an object. The electric driver 431 is provided with a trigger switch 432 operated by a user.

A battery pack 430 and a motor control unit 435 are housed in a lower housing of a handle of the electric driver 431. The motor control unit 435 controls the motor 433. Each part of the electric driver 431 other than the motor 433 may be controlled by the motor control unit 435. Although not shown, the battery pack 430 and the electric driver 431 are engaged with each other by an engaging member provided therein. As will be described later, a microcomputer is provided in each of the battery pack 430 and the motor control unit 435. A battery power source is supplied from the battery pack 430 to the motor control unit 435, and information on the battery pack 430 is communicated between the two microcomputers.

The battery pack 430 is detachable from, for example, the electric driver 431. The battery pack 430 may be built in the electric driver 431. The battery pack 430 is attached to a charging apparatus during charging. When the battery pack 430 is attached to the electric driver 431, a part of the battery pack 430 may be exposed to the outside of the electric driver 431 so that the user can visually recognize the exposed portion. For example, an LED may be provided on the exposed portion of the battery pack 430 so that the user can confirm whether the LED is emitted or turned off. As the battery pack 430, the battery pack of an embodiment can be applied.

The motor control unit 435 controls, for example, the rotation/stop and the rotation direction of the motor 433. Further, the motor control unit 435 shuts off the power supply to the load at the time of overdischarging. The trigger switch 432 is inserted, for example, between the motor 433 and the motor control unit 435, and when the user presses the trigger switch 432, power is supplied to the motor 433 and the motor 433 rotates. When the user returns the trigger switch 432, the rotation of the motor 433 is stopped.

Examples of the electric vehicles include an electric car and an electric bicycle. As an example in which the present technology is applied to an electric vehicle power storage system, FIG. 14 schematically shows a configuration example of a hybrid vehicle (HV) employing a series hybrid system. The series hybrid system is a car travelling with an electric power driving force converter using electric power generated by a generator powered by an engine or electric power obtained by temporarily storing the generated electric power in a battery.

A hybrid vehicle 600 is mounted with an engine 601, a generator 602, the electric power driving force converter (direct-current motor or alternate-current motor; hereinafter, it is simply referred to as “motor 603”), a driving wheel 604a, a driving wheel 604b, a wheel 605a, a wheel 605b, a battery 608, a vehicle control device 609, various sensors 610, and a charging port 611. As the battery 608, the battery pack described in an embodiment can be applied.

The motor 603 is operated by the electric power of the battery 608, and a rotating force of the motor 603 is transmitted to the driving wheels 604a and 604b. The battery 608 can store the electric power generated at the generator 602 by the rotating force produced by the engine 601. The various sensors 610 control an engine speed via the vehicle control device 609, or control an opening degree of a throttle valve, not shown.

When the hybrid vehicle 600 is decelerated by a brake mechanism, not shown, a resistance force during the deceleration is added as a rotating force to the motor 603, and regenerative electric power generated due to this rotating force is stored in the battery 608. In addition, the battery 608 can be charged by being connected to an external power supply via the charging port 611 of the hybrid vehicle 600. Such an HV vehicle is referred to as a plug-in hybrid vehicle (PHV or PHEV).

It is to be noted that the electric storage device according to the present technology can also be applied to a downsized primary battery, and then used as a power supply for a pneumatic sensor system (tire pressure monitoring system (TPMS)) built in the wheels 604 and 605.

Although a series hybrid vehicle has been described above as an example, the present technology is also applicable to a hybrid vehicle of a parallel system using an engine and a motor together or a hybrid vehicle in which a series system and a parallel system are combined. In addition, the present technology is also applicable to an electric vehicle (EV or BEV) and a fuel cell vehicle (FCV) that travel only by a drive motor without using an engine. In addition, the present technology is also applicable to an electric bicycle.

Since the battery pack described in an embodiment can be applied as the battery 608, when an abnormality occurs in the battery cell housed in the battery pack and gas is blown out from the battery cell to the internal space of the exterior case, the gas can be quickly discharged from the battery pack, which can suppress an accident of the electric car due to rupture of the battery pack (rupture of an electric storage device).

One or more embodiments of the present application have been described herein including with reference to examples; however, the present application is not limited thereto, and various modifications can be made.

For example, the configurations, the methods, the processes, the shapes, the materials, the numerical values, and the like mentioned in the above-described embodiments including application examples are merely examples. Different configurations, methods, processes, shapes, materials, numerical values, and the like may be used as necessary. The configuration, the methods, the processes, the shapes, the materials, the numerical values and the like in the above-described embodiments including application examples may be suitably combined according to an embodiment.

### DESCRIPTION OF REFERENCE SYMBOLS

1: Battery pack
2: Exterior case
3A: First connection member
3B: Second connection member
4: Battery cell
5A: Lead plate
5B: Lead plate
5C: Lead plate
6: End portion
9: Film material
11A: Adhesive member
12: Battery holder
13: Battery cell housing portion
15A: Positive electrode terminal portion
15B: Negative electrode terminal portion
20: Peripheral wall portion
21: Thin portion
22: Terminal facing portion
22A: Positive electrode facing portion
22B: Negative electrode facing portion
23: Welded portion
25: Rib
27: Cutout portion
30: Insulating portion
30A: Opening portion
31: Facing surface
32: Non-facing surface
50: Conductive portion
60: Opening
111: Battery can
114: Battery lid
200: Electric bicycle
431: Electric driver

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery pack comprising:
a battery cell;
a battery holder that houses the battery cell; and
a connection member that electrically connects the battery cell, wherein
the battery holder has an end portion covering a side circumferential surface of the battery cell and providing an opening on a terminal portion side of the battery cell,
the connection member includes a conductive portion and an insulating portion, and
at least a part of the insulating portion and the end portion are connected with an adhesive member.

2. The battery pack according to claim 1, wherein
the connection member includes a thin portion at a terminal facing portion that faces the terminal portion of the battery cell and that is provided at a portion where the adhesive member is not disposed.

3. The battery pack according to claim 2, wherein
a welded portion where the conductive portion and the terminal portion of the battery cell are welded to each other is provided, and
the thin portion is formed in a portion excluding the welded portion.

4. The battery pack according to claim 2, wherein
the thin portion is provided in a cross shape or a circular shape.

5. The battery pack according to claim 2, wherein
a thin portion is provided on at least one of a positive electrode facing portion facing the terminal portion of a positive electrode of the battery cell and a negative electrode facing portion facing the terminal portion of a negative electrode of the battery cell among the terminal facing portions.

6. The battery pack according to claim 5, wherein
a thin portion is provided on the positive electrode facing portion and the negative electrode facing portion.

7. The battery pack according to claim 1, wherein
the connection member includes a thin portion in a portion that faces the terminal portion of the battery cell and that corresponds to an outer periphery of a terminal facing portion provided in a portion where the adhesive member is not disposed.

8. The battery pack according to claim 7, wherein
the thin portion is provided along an outer periphery of the conductive portion.

9. The battery pack according to claim 7, wherein
a thin portion is provided on a portion corresponding to an outer periphery of at least one of a positive electrode facing portion facing the terminal portion of a positive electrode of the battery cell and a negative electrode facing portion facing the terminal portion of a negative electrode of the battery cell among the terminal facing portions.

10. The battery pack according to claim 9, wherein
a thin portion is provided on a portion corresponding to an outer periphery of the positive electrode facing portion and the negative electrode facing portion.

11. The battery pack according to claim 1, wherein
an exterior case having a space for housing the battery holder is provided, and
the exterior case is provided with a rib in contact with the connection member on its inner surface.

12. The battery pack according to claim 11, wherein
the rib is provided at a position avoiding a position where the rib overlaps the terminal portion of the battery cell.

13. The battery pack according to claim 11, wherein
a cutout portion is provided in the rib.

14. The battery pack according to claim 1, wherein
the end portion is located outside the terminal portion of the battery cell.

15. The battery pack according to claim 1, wherein
the insulating portion includes a film material, and
the conductive portion includes a metal member.

16. The battery pack according to claim 1, wherein
the adhesive member is provided in an entire region of the end portion of the battery holder.

17. The battery pack according to claim 1, wherein
the adhesive member includes an acrylic-based resin adhesive or a silicon-based resin adhesive.

18. The battery pack according to claim 1, wherein
the connection member exposes the conductive portion to a non-facing surface side toward the battery cell.

19. An electric tool comprising
the battery pack according to claim 1.

20. An electric vehicle comprising
the battery pack according to claim 1.
